(19) United States
(12) Patent Application Publication
(10) Pub. No.: US 2025/0342353 A1
(43) Pub. Date: Nov. 6, 2025

(54) SYSTEM AND METHOD FOR EVALUATING LARGE LANGUAGE MODELS ON TIME SERIES FEATURE UNDERSTANDING

(71) Applicant: JPMorgan Chase Bank, N.A., New York, NY (US)

(72) Inventors: Elizabeth FONS, London (GB); Rachneet KAUR, Manhattan, NY (US); Zhen ZENG, Ypsilanti, MI (US); Svitlana VYETRENKO, Berkeley, CA (US); Tucker Richard BALCH, Suwanee, GA (US)

(73) Assignee: JPMorgan Chase Bank, N.A., New York, NY (US)

(21) Appl. No.: 18/654,662

(22) Filed: May 3, 2024

(51) Int. Cl. G06N 3/08

(52) U.S. Cl. CPC G06N 3/08

(57) ABSTRACT

Various methods and processes, apparatuses or systems, and media for evaluating LLMs on time series feature understanding are disclosed. A processor implements a pre-trained LLM; generates a comprehensive taxonomy for evaluating analytical capabilities of the LLM in a context of time series data, the comprehensive taxonomy including a feature and a corresponding sub-category of the feature. In evaluating analytical capabilities of the LLM in the context of time series data, the processor determines whether the LLM can detect the feature; and when it is determined that the LLM can detect the feature, determines whether the LLM can identify the sub-category of the feature; automatically generates a feature detection and classification score for the LLM indicating performance time series information retrieval and arithmetic reasoning performance measured by accuracy for different time series; and displays the score onto a graphical user interface.

### TECHNICAL FIELD

This disclosure generally relates to data processing, and, more particularly, to methods and apparatuses for implementing a platform, language, cloud, and database agnostic Large Language Model (LLM) evaluating module configured for rigorously evaluating the capabilities of LLMs on time series understanding, encompassing both univariate and multivariate forms.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Time series analysis and reporting may play a crucial role in many areas like healthcare, finance, climate, etc. With the recent advances in LLMs, integrating them in time series analysis and reporting processes presents a huge potential for automation. Recent works have adapted general-purpose LLMs for time series understanding in various specific domains, such as seizure localization in electroencephalogram (EEG) time series, cardiovascular disease diagnosis in ECG time series, weather and climate data understanding, and explainable financial time series forecasting.

LLMs are typically characterized as pre-trained, Transformer-based models endowed with an immense number of parameters, spanning from tens to hundreds of billions, and crafted through the extensive training on vast text datasets. These models have surpassed expectations in numerous language-related tasks and extended their utility to areas beyond traditional natural language processing. For instance, LLMs may be leveraged for the prediction and modeling of human mobility, for explainable financial time series forecasting, and for seizure localization.

Despite their advanced capabilities, LLMs tend to face challenges with basic arithmetic tasks, crucial for time series analysis involving quantitative data. For example, despite advancements in domain-specific LLMs for time series understanding, it may prove to be crucial to conduct a systematic evaluation of general-purpose LLMs' inherent capabilities in generic time series understanding, without domain-specific fine-tuning. Research has identified challenges such as inconsistent tokenization and token frequency as major barriers. Certain solutions to digit tokenization highlight ongoing efforts to refine LLMs' arithmetic abilities, enhancing their applicability in time series analysis.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic LLM evaluating module configured for rigorously evaluating the capabilities of LLMs on time series understanding, encompassing both univariate and multivariate forms, but the disclosure is not limited thereto.

For example, to systematically evaluate the performance of general-purpose LLMs on generic time series understanding, the LLM evaluating module as disclosed herein may be configured to generate a taxonomy of time series features for both univariate and multivariate time series. This taxonomy provides a structured categorization of core characteristics of time series across domains. Building upon this taxonomy, the LLM evaluating module as disclosed herein may configured to synthesize a diverse dataset of time series covering different features in the taxonomy. This dataset may prove to be pivotal to the evaluation framework, as it provides a robust basis for assessing LLMs' ability to interpret and analyze time series data accurately. Specifically, the LLM evaluating module as disclosed herein may configured to examine the state-of-the-art LLMs' performance across a range of tasks on a vast number of dataset, including time series features detection and classification, data retrieval as well as arithmetic reasoning, but the disclosure is not limited thereto.

According to exemplary embodiments, a method for evaluating large language models on time series feature understanding by utilizing one or more processors along with allocated memory is disclosed. The method may include: implementing a pre-trained LLM; generating a comprehensive taxonomy for evaluating analytical capabilities of the LLM in a context of time series data, the comprehensive taxonomy including a feature and a corresponding sub-category of the feature, wherein in evaluating analytical capabilities of the LLM in the context of time series data, the method may further include: determining whether the LLM can detect the feature; when it is determined that the LLM can detect the feature, determining whether the LLM can identify the sub-category of the feature; automatically generating a feature detection and classification score for the LLM indicating performance time series information retrieval and arithmetic reasoning performance measured by accuracy for different time series; and displaying the score onto a graphical user interface for evaluating the capabilities of the LLM in understanding and interpreting the time series data.

According to exemplary embodiments, the comprehensive taxonomy may categorize intrinsic characteristics of time series features, providing a structured basis for assessing proficiency of the LLM in identifying and extracting these features.

According to exemplary embodiments, the method may further include: designing time series of datasets corresponding to the generated comprehensive taxonomy; outlining an evaluation framework incorporating specific metrics to quantify performance of the LLM model across a plurality of tasks; and implementing the evaluation framework to quantify performance of the LLM model across the plurality of tasks.

According to exemplary embodiments, in determining whether the LLM can detect the feature, the method may further include: querying the model to identify relevant features within the time series data.

According to exemplary embodiments, the method may further include: when it is determined that the LLM has successfully detected the feature, implementing a follow-up prompt designed to classify the identified feature between multiple sub-categories.

According to exemplary embodiments, the method may further include: enriching the prompts with definitions of each sub-category.

According to exemplary embodiments, the method may further include: testing the LLM's comprehension of numerical data represented as text by querying the LLM for information retrieval and numerical reasoning.

According to exemplary embodiments, a system for evaluating large language models on time series feature understanding is disclosed. The system comprising: a processor; and a memory operatively connected to the processor via a communication interface, the memory storing computer readable instructions, when executed, may cause the processor to: implement a pre-trained LLM; generate a comprehensive taxonomy for evaluating analytical capabilities of the LLM in a context of time series data, the comprehensive taxonomy including a feature and a corresponding sub-category of the feature, wherein in evaluating analytical capabilities of the LLM in the context of time series data, the processor may be further configured to: determine whether the LLM can detect the feature; when it is determined that the LLM can detect the feature, determine whether the LLM can identify the sub-category of the feature; automatically generate a feature detection and classification score for the LLM indicating performance time series information retrieval and arithmetic reasoning performance measured by accuracy for different time series; and display the score onto a graphical user interface for evaluating the capabilities of the LLM in understanding and interpreting the time series data.

According to exemplary embodiments, the processor may be further configured to: design time series of datasets corresponding to the generated comprehensive taxonomy; outline an evaluation framework incorporating specific metrics to quantify performance of the LLM model across a plurality of tasks; and implement the evaluation framework to quantify performance of the LLM model across the plurality of tasks.

According to exemplary embodiments, in determining whether the LLM can detect the feature, the processor may be further configured to: query the model to identify relevant features within the time series data.

According to exemplary embodiments, the processor may be further configured to: when it is determined that the LLM has successfully detected the feature, implement a follow-up prompt designed to classify the identified feature between multiple sub-categories.

According to exemplary embodiments, the processor may be further configured to: enrich the prompts with definitions of each sub-category.

According to exemplary embodiments, the processor may be further configured to: test the LLM's comprehension of numerical data represented as text by querying the LLM for information retrieval and numerical reasoning.

According to exemplary embodiments, a non-transitory computer readable medium configured to store instructions for evaluating large language models on time series feature understanding, the instructions, when executed, may cause a processor to perform the following: implementing a pre-trained LLM; generating a comprehensive taxonomy for evaluating analytical capabilities of the LLM in a context of time series data, the comprehensive taxonomy including a feature and a corresponding sub-category of the feature, wherein in evaluating analytical capabilities of the LLM in the context of time series data, the instructions, when executed, may cause the processor to further perform the following: determining whether the LLM can detect the feature; when it is determined that the LLM can detect the feature, determining whether the LLM can identify the sub-category of the feature; automatically generating a feature detection and classification score for the LLM indicating performance time series information retrieval and arithmetic reasoning performance measured by accuracy for different time series; and displaying the score onto a graphical user interface for evaluating the capabilities of the LLM in understanding and interpreting the time series data.

According to exemplary embodiments, the instructions, when executed, may cause the processor to further perform the following: designing time series of datasets corresponding to the generated comprehensive taxonomy; outlining an evaluation framework incorporating specific metrics to quantify performance of the LLM model across a plurality of tasks; and implementing the evaluation framework to quantify performance of the LLM model across the plurality of tasks.

According to exemplary embodiments, in determining whether the LLM can detect the feature, the instructions, when executed, may cause the processor to further perform the following: querying the model to identify relevant features within the time series data.

According to exemplary embodiments, the instructions, when executed, may cause the processor to further perform the following: when it is determined that the LLM has successfully detected the feature, implementing a follow-up prompt designed to classify the identified feature between multiple sub-categories.

According to exemplary embodiments, the instructions, when executed, may cause the processor to further perform the following: enriching the prompts with definitions of each sub-category.

According to exemplary embodiments, the instructions, when executed, may cause the processor to further perform the following: testing the LLM's comprehension of numerical data represented as text by querying the LLM for information retrieval and numerical reasoning.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic LLM evaluating module configured for evaluating the capabilities of LLMs on time series understanding, encompassing both univariate and multivariate forms in accordance with an exemplary embodiment.

FIG. 2 illustrates an exemplary diagram of a network environment with a platform, language, database, and cloud agnostic LLM evaluating device in accordance with an exemplary embodiment.

FIG. 3 illustrates a system diagram for implementing a platform, language, database, and cloud agnostic LLM evaluating device having a platform, language, database, and cloud agnostic LLM evaluating module in accordance with an exemplary embodiment.

FIG. 4 illustrates a system diagram for implementing a platform, language, database, and cloud agnostic LLM evaluating module of FIG. 3 in accordance with an exemplary embodiment.

FIG. 5 illustrates an exemplary table illustrating taxonomy of time series characteristics implemented by the platform, language, database, and cloud agnostic LLM evaluating module of FIG. 4 in accordance with an exemplary embodiment.

FIG. 6 illustrates an exemplary graph illustrating examples of generated univariate time series implemented by the platform, language, database, and cloud agnostic LLM evaluating module of FIG. 4 in accordance with an exemplary embodiment.

FIG. 7 illustrates an exemplary table illustrating performances across all reasoning tasks implemented by the platform, language, database, and cloud agnostic LLM evaluating module of FIG. 4 in accordance with an exemplary embodiment.

FIG. 8 illustrates an exemplary graph illustrating feature detection and classification scores of various models implemented by the platform, language, database, and cloud agnostic LLM evaluating module of FIG. 4 in accordance with an exemplary embodiment.

FIG. 9 illustrates an exemplary table illustrating time series feature detection and classification performance measured with F1 score implemented by the platform, language, database, and cloud agnostic LLM evaluating module of FIG. 4 in accordance with an exemplary embodiment.

FIG. 10 illustrates an exemplary graph illustrating retrieval performance for different time series lengths implemented by the platform, language, database, and cloud agnostic LLM evaluating module of FIG. 4 in accordance with an exemplary embodiment.

FIG. 11 illustrates an exemplary flow chart of a process implemented by the platform, language, database, and cloud agnostic LLM evaluating module of FIG. 4 for evaluating the capabilities of LLMs on time series understanding, encompassing both univariate and multivariate forms in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

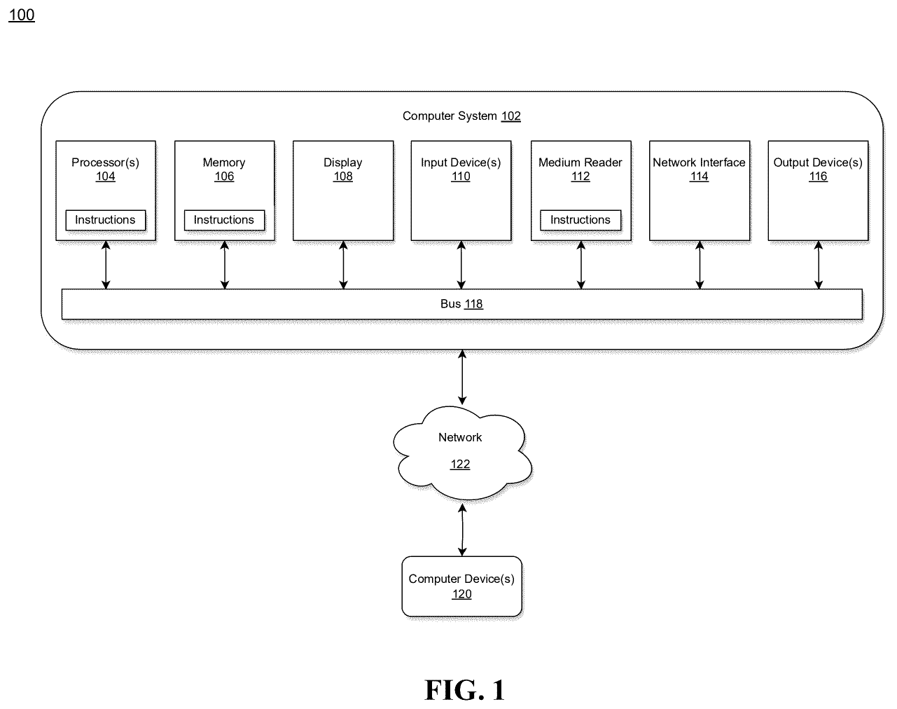

FIG. 1 is an exemplary system 100 for use in implementing a platform, language, database, and cloud agnostic LLM evaluating module configured for evaluating the capabilities of LLMs on time series understanding, encompassing both univariate and multivariate forms in accordance with an exemplary embodiment. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

According to exemplary embodiments, the LLM evaluating module implemented by the system 100 may be platform, language, database, and cloud agnostic that may allow for consistent easy orchestration and passing of data through various components to output a desired result regardless of platform, browser, language, database, and cloud environment by writing programs accordingly. Since the disclosed process, according to exemplary embodiments, is platform, language, database, browser, and cloud agnostic, the LLM evaluating module may be independently tuned or modified for optimal performance without affecting the configuration or data files. The configuration or data files, according to exemplary embodiments, may be written using JSON, but the disclosure is not limited thereto. For example, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

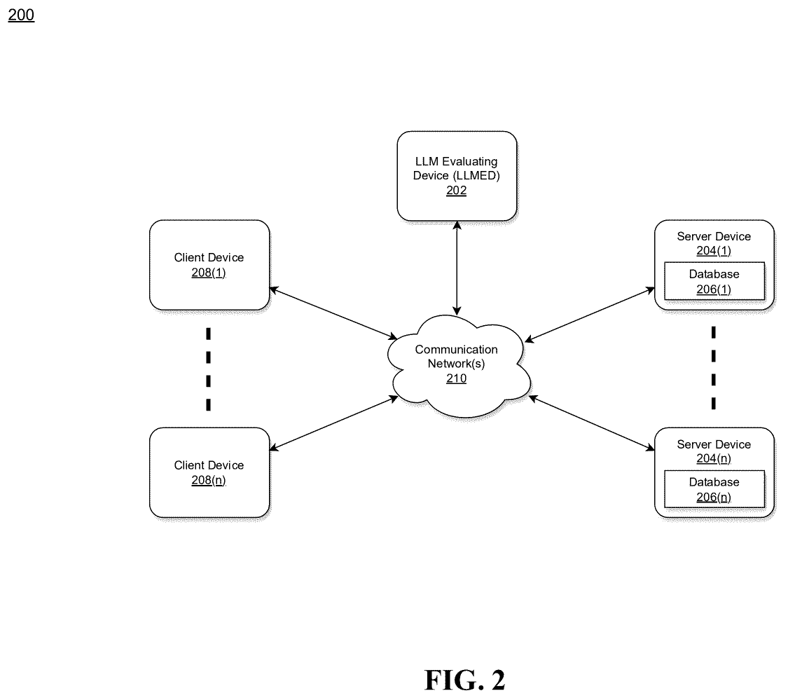

Referring to FIG. 2, a schematic of an exemplary network environment 200 for implementing a language, platform, database, and cloud agnostic LLM evaluating device (LLMED) of the instant disclosure is illustrated.

According to exemplary embodiments, the above-described problems associated with conventional tools may be overcome by implementing an LLMED 202 as illustrated in FIG. 2 that may be configured for implementing a platform, language, database, and cloud agnostic LLM evaluating module configured for evaluating the capabilities of LLMs on time series understanding, encompassing both univariate and multivariate forms, but the disclosure is not limited thereto. For example, to systematically evaluate the performance of general-purpose LLMs on generic time series understanding, the LLMED 202 as disclosed herein may be configured to generate a taxonomy of time series features for both univariate and multivariate time series. This taxonomy provides a structured categorization of core characteristics of time series across domains. Building upon this taxonomy, the LLMED 202 as disclosed herein may configured to synthesize a diverse dataset of time series covering different features in the taxonomy. This dataset may prove to be pivotal to the evaluation framework, as it provides a robust basis for assessing LLMs' ability to interpret and analyze time series data accurately. Specifically, the LLMED 202 as disclosed herein may configured to examine the state-of-the-art LLMs' performance across a range of tasks on a vast number of dataset, including time series features detection and classification, data retrieval as well as arithmetic reasoning, but the disclosure is not limited thereto.

The LLMED 202 may have one or more computer system 102s, as described with respect to FIG. 1, which in aggregate provide the necessary functions.

The LLMED 202 may store one or more applications that can include executable instructions that, when executed by the LLMED 202, cause the LLMED 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the LLMED 202 itself, may be located in virtual server(s) running in a cloud-based computing environment rather than being tied to one or more specific physical network computing devices. Also, the application(s) may be running in one or more virtual machines (VMs) executing on the LLMED 202. Additionally, in one or more embodiments of this technology, virtual machine(s) running on the LLMED 202 may be managed or supervised by a hypervisor.

In the network environment 200 of FIG. 2, the LLMED 202 is coupled to a plurality of server devices 204(1)-204(n) that hosts a plurality of databases 206(1)-206(n), and also to a plurality of client devices 208(1)-208(n) via communication network(s) 210. A communication interface of the LLMED 202, such as the network interface 114 of the computer system 102 of FIG. 1, operatively couples and communicates between the LLMED 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the LLMED 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The LLMED 202 may be a standalone device or integrated with one or more other devices or apparatuses, such as one or more of the server devices 204(1)-204(n), for example. In one particular example, the LLMED 202 may be hosted by one of the server devices 204(1)-204(n), and other arrangements are also possible. Moreover, one or more of the devices of the LLMED 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the LLMED 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the LLMED 202 that may efficiently provide a platform for implementing a platform, language, database, and cloud agnostic LLM evaluating module configured for evaluating the capabilities of LLMs on time series understanding, encompassing both univariate and multivariate forms, but the disclosure is not limited thereto.

The client devices 208(1)-208(n) may run interface applications, such as standard web browsers or standalone client applications, which may provide an interface to communicate with the LLMED 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the LLMED 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the LLMED 202, the server devices 204(1)-204(n), or the client devices 208(1)-208(n), for example, may be configured to operate as virtual instances on the same physical machine. For example, one or more of the LLMED 202, the server devices 204(1)-204(n), or the client devices 208(1)-208(n) may operate on the same physical device rather than as separate devices communicating through communication network(s) 210. Additionally, there may be more or fewer LLMEDs 202, server devices 204(1)-204(n), or client devices 208(1)-208(n) than illustrated in FIG. 2. According to exemplary embodiments, the LLMED 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

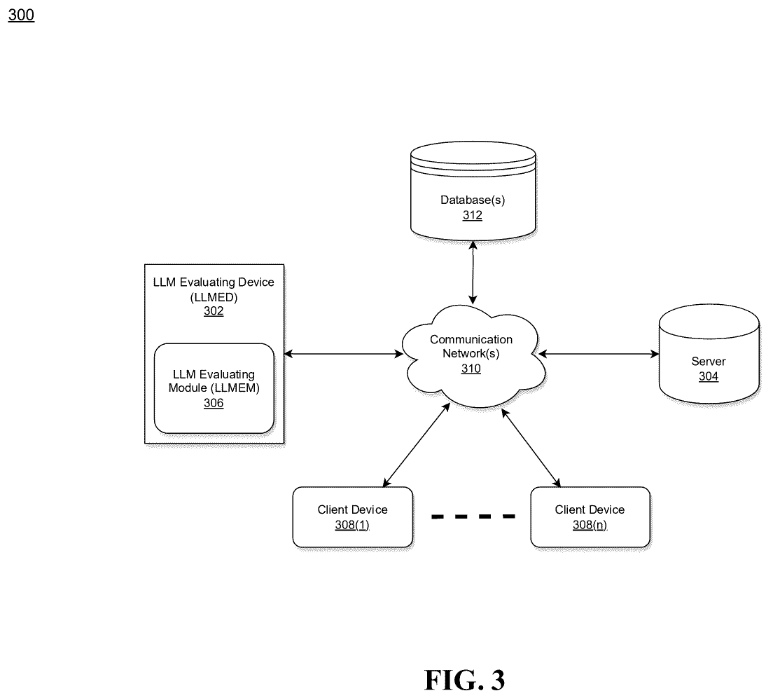

FIG. 3 illustrates a system diagram for implementing a platform, language, and cloud agnostic LLMED having a platform, language, database, and cloud agnostic LLM evaluating module (LLMEM) in accordance with an exemplary embodiment.

As illustrated in FIG. 3, the system 300 may include an LLMED 302 within which an LLMEM 306 is embedded, a server 304, a database(s) 312, a plurality of client devices 308(1) . . . 308(n), and a communication network 310.

According to exemplary embodiments, the LLMED 302 including the LLMEM 306 may be connected to the server 304, and the database(s) 312 via the communication network 310. The LLMED 302 may also be connected to the plurality of client devices 308(1) . . . 308(n) via the communication network 310, but the disclosure is not limited thereto. The database(s) 312 may include rule database.

According to exemplary embodiment, the LLMED 302 is described and shown in FIG. 3 as including the LLMEM 306, although it may include other rules, policies, modules, databases, or applications, for example. According to exemplary embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

According to exemplary embodiments, the LLMEM 306 may be configured to receive real-time feed of data from the plurality of client devices 308(1) . . . 308(n) and secondary sources via the communication network 310.

As may be described below, the LLMEM 306 may be configured to: implement a pre-trained LLM; generate a comprehensive taxonomy for evaluating analytical capabilities of the LLM in a context of time series data, the comprehensive taxonomy including a feature and a corresponding sub-category of the feature, wherein in evaluating analytical capabilities of the LLM in the context of time series data, the processor may be further configured to: determine whether the LLM can detect the feature; when it is determined that the LLM can detect the feature, determine whether the LLM can identify the sub-category of the feature; automatically generate a feature detection and classification score for the LLM indicating performance time series information retrieval and arithmetic reasoning performance measured by accuracy for different time series; and display the score onto a graphical user interface for evaluating the capabilities of the LLM in understanding and interpreting the time series data, but the disclosure is not limited thereto.

The plurality of client devices 308(1) . . . 308(n) are illustrated as being in communication with the LLMED 302. In this regard, the plurality of client devices 308(1) . . . 308(n) may be “clients” (e.g., customers) of the LLMED 302 and are described herein as such. Nevertheless, it is to be known and understood that the plurality of client devices 308(1) . . . 308(n) need not necessarily be “clients” of the LLMED 302, or any entity described in association therewith herein. Any additional or alternative relationship may exist between either or both of the plurality of client devices 308(1) . . . 308(n) and the LLMED 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the LLMED 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The LLMED 302 may be the same or similar to the LLMED 202 as described with respect to FIG. 2, including any features or combination of features described with respect thereto.

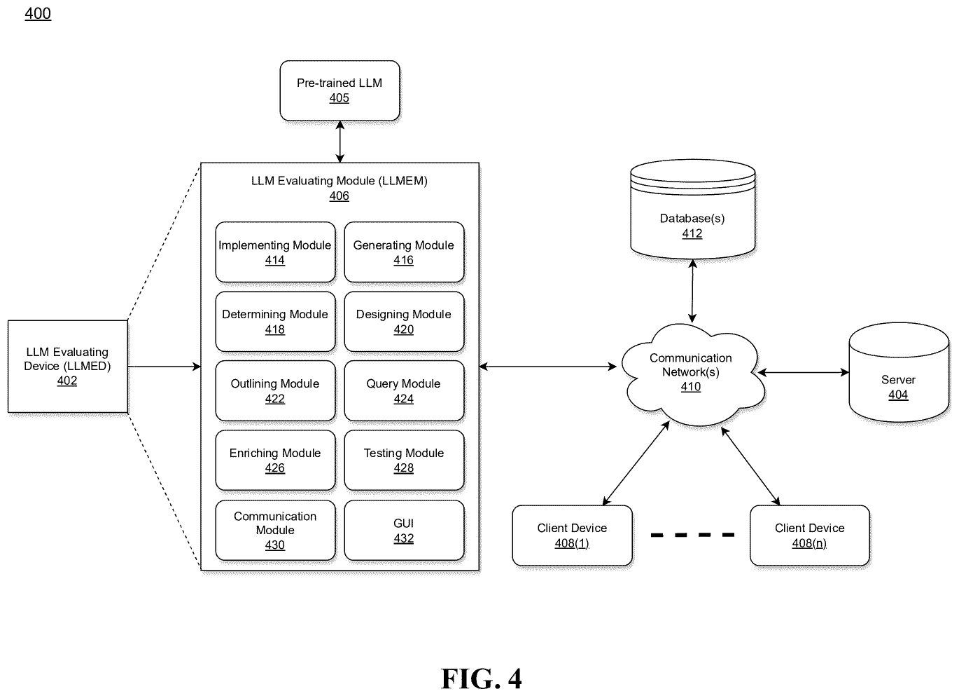

FIG. 4 illustrates a system diagram for implementing a platform, language, database, and cloud agnostic LLMEM of FIG. 3 in accordance with an exemplary embodiment.

According to exemplary embodiments, the system 400 may include a platform, language, database, and cloud agnostic LLMED 402 within which a platform, language, database, and cloud agnostic LLMEM 406 is embedded, a server 404, database(s) 412, and a communication network 410. According to exemplary embodiments, server 404 may comprise a plurality of servers located centrally or located in different locations, but the disclosure is not limited thereto.

According to exemplary embodiments, the LLMED 402 including the LLMEM 406 may be connected to the server 404, a pre-trained LLM 405, and the database(s) 412 via the communication network 410. The LLMED 402 may also be connected to the plurality of client devices 408(1)-408(n) via the communication network 410, but the disclosure is not limited thereto. The LLMEM 406, the server 404, the plurality of client devices 408(1)-408(n), the database(s) 412, the communication network 410 as illustrated in FIG. 4 may be the same or similar to the LLMEM 306, the server 304, the plurality of client devices 308(1)-308(n), the database(s) 312, the communication network 310, respectively, as illustrated in FIG. 3.

According to exemplary embodiments the LLMEM 406 may be configured to evaluate the capabilities of LLMs (i.e., one or more of the pre-trained LLMs 405) on time series understanding, encompassing both univariate and multivariate forms, but the disclosure is not limited thereto. For example, to systematically evaluate the performance of general-purpose LLMs on generic time series understanding, the LLMEM 406 as disclosed herein may be configured to generate a taxonomy of time series features for both univariate and multivariate time series. This taxonomy provides a structured categorization of core characteristics of time series across domains. Building upon this taxonomy, the LLMEM 406 as disclosed herein may configured to synthesize a diverse dataset of time series covering different features in the taxonomy. This dataset may prove to be pivotal to the evaluation framework, as it provides a robust basis for assessing LLMs' ability to interpret and analyze time series data accurately. Specifically, the LLMEM 406 as disclosed herein may configured to examine the state-of-the-art LLMs' performance across a range of tasks on a vast number of dataset, including time series features detection and classification, data retrieval as well as arithmetic reasoning, but the disclosure is not limited thereto.

Details of the LLMEM 406 is provided below with corresponding modules that may be configured to, in combination, results in evaluating the capabilities of LLMs (i.e., one or more of the pre-trained LLMs 405) on time series understanding, encompassing both univariate and multivariate forms, as illustrated in FIGS. 4-11.

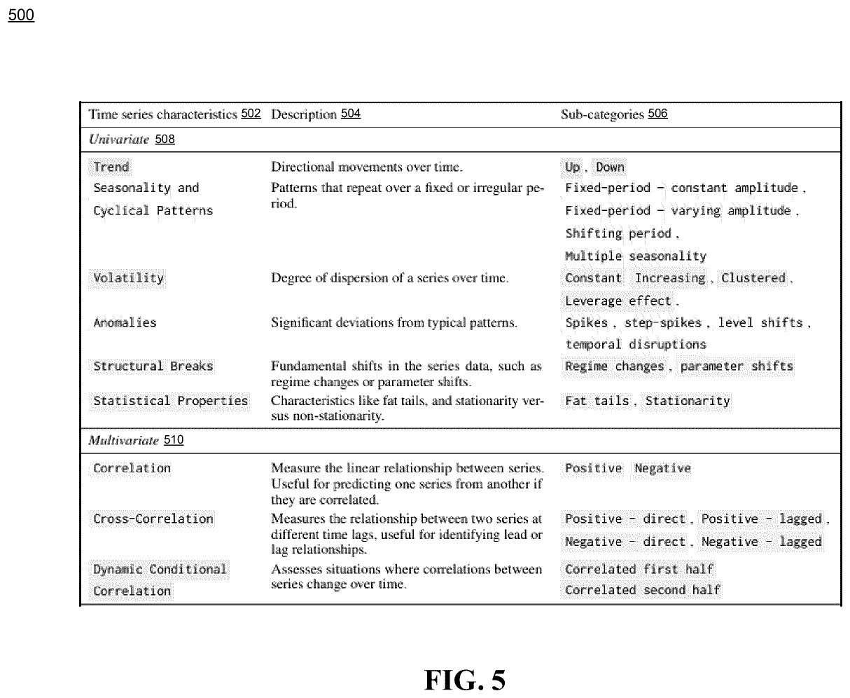

According to exemplary embodiments, as illustrated in FIG. 4, the LLMEM 406 may include an implementing module 414, a generating module 416, a determining module 418, a designing module 420, an outlining module 422, a query module 424, an enriching module 426, a testing module 428, a communication module 430, and a GUI 432. According to exemplary embodiments, interactions and data exchange among these modules included in the LLMEM 406 provide the advantageous effects of the disclosed invention. Functionalities of each module of FIG. 4 may be described in detail below with reference to FIGS. 5-11.

According to exemplary embodiments, each of the implementing module 414, generating module 416, determining module 418, designing module 420, outlining module 422, query module 424, enriching module 426, testing module 428, and the communication module 430 of the LLMEM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each of the implementing module 414, generating module 416, determining module 418, designing module 420, outlining module 422, query module 424, enriching module 426, testing module 428, and the communication module 430 of the LLMEM 406 of FIG. 4 may be implemented by microprocessors or similar, and may be programmed using software (e.g., microcode) to perform various functions discussed herein and may optionally be driven by firmware and/or software.

Alternatively, according to exemplary embodiments, each of the implementing module 414, generating module 416, determining module 418, designing module 420, outlining module 422, query module 424, enriching module 426, testing module 428, and the communication module 430 of the LLMEM 406 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. For example, the LLMEM 406 of FIG. 4 may also be implemented by Cloud based deployment.

According to exemplary embodiments, each of the implementing module 414, generating module 416, determining module 418, designing module 420, outlining module 422, query module 424, enriching module 426, testing module 428, and the communication module 430 of the LLMEM 406 of FIG. 4 may be called via corresponding API, but the disclosure is not limited thereto.

According to exemplary embodiments, the process implemented by the LLMEM 406 may be executed via the communication module 430 and the communication network 410, which may comprise plural networks as described above. For example, in an exemplary embodiment, the various components of the LLMEM 406 may communicate with the server 404, and the database(s) 412 via the communication module 430 and the communication network 410 and the results (i.e., probability value; empirical estimate, etc.) may be displayed onto the GUI 432. Of course, these embodiments are merely exemplary and are not limiting or exhaustive. The database(s) 412 may include the databases included within the private cloud and/or public cloud and the server 404 may include one or more servers within the private cloud and the public cloud.

According to exemplary embodiments, the implementing module 414 may be configured to implement a pre-trained LLM 405. The generating module 416 may be configured to generate a comprehensive taxonomy for evaluating analytical capabilities of the pre-trained LLM 405 in a context of time series data, the comprehensive taxonomy including a feature and a corresponding sub-category of the feature. In evaluating analytical capabilities of the pre-trained LLM 405 in the context of time series data, the determining module 418 may be further configured to: determine whether the pre-trained LLM 405 can detect the feature; when it is determined that the pre-trained LLM 405 can detect the feature, determine whether the pre-trained LLM 405 can identify the sub-category of the feature; automatically generate a feature detection and classification score for the pre-trained LLM 405 indicating performance time series information retrieval and arithmetic reasoning performance measured by accuracy for different time series. The score may be displayed onto the GUI 432 for evaluating the capabilities of the pre-trained LLM 405 in understanding and interpreting the time series data.

According to exemplary embodiments, the designing module 420 may be configured to design time series of datasets corresponding to the generated comprehensive taxonomy. The outlining module 422 may be configured to outline an evaluation framework incorporating specific metrics to quantify performance of the pre-trained LLM 405 across a plurality of tasks; and the implementing module 414 may be further configured to implement the evaluation framework to quantify performance of the pre-trained LLM 405 across the plurality of tasks.

According to exemplary embodiments, in determining whether the pre-trained LLM 405 can detect the feature, the query module 424 may be configured to query the pre-trained LLM 405 to identify relevant features within the time series data.

According to exemplary embodiments, when it is determined that the pre-trained LLM 405 has successfully detected the feature, implement a follow-up prompt designed to classify the identified feature between multiple sub-categories.

According to exemplary embodiments, the enriching module 426 may be configured to enrich the prompts with definitions of each sub-category.

According to exemplary embodiments, the testing module 428 may be further configured to test the pre-trained LLM's 405 comprehension of numerical data represented as text by querying the pre-trained LLM 405 for information retrieval and numerical reasoning.

For as disclosed herein, the LLMEM 406 may implement a taxonomy that provides a systematic categorization of important time series features, an essential tool for standardizing the evaluation of LLMs in time series understanding.

According to exemplary embodiments, for the diverse time series dataset, the LLMEM 406 synthesizes a comprehensive time series dataset, ensuring a broad representation of the various types of time series, encompassing the spectrum of features identified in the taxonomy.

According to exemplary embodiments, evaluations of LLMs may provide insights into what LLMs do well when it comes to understanding time series and where they struggle, including how they deal with the format of the data, where the query data points are located in the series, how long the time series is, but the disclosure is not limited thereto.

The LLMEM 406, according to exemplary embodiments, may implement a comprehensive taxonomy for evaluating the analytical capabilities of LLMs 405 in the context of time series data. This taxonomy categorizes the intrinsic characteristics of time series, providing a structured basis for assessing the proficiency of LLMs 405 in identifying and extracting these features. Furthermore, the LLMEM 406 designs a series of datasets following the proposed taxonomy and outlines an evaluation framework, incorporating specific metrics to quantify model performance accurately across various tasks.

For example, FIG. 5 illustrates an exemplary table 500 illustrating taxonomy of time series characteristics implemented by the LLMEM 406 of FIG. 4 in accordance with an exemplary embodiment. The proposed taxonomy encompasses critical aspects of time series data that are frequently analyzed for different applications. The table 500 may include a column for time series characteristics 502, a column for description 504, and column for sub-categories 506. As illustrated in the table 500, the LLMEM 406 may be configured for evaluating the capabilities of LLMs on time series understanding, encompassing both univariate 508 and multivariate 510 forms in accordance with an exemplary embodiment. The table 500 shows the selected features in increasing complexity, and each sub-feature. The LLMEM 406 evaluates the LLM in this taxonomy in a two-step process. In first place, we evaluate if the LLM can detect the feature, and in a second step, the LLMEM 406 evaluates if the LLM can identify the sub-category of the feature. A detailed description of the process is described later.

Leveraging the taxonomy, the LLMEM 406 may be configured to construct a diverse synthetic dataset of time series, covering the features outlined in the previous section. According to exemplary embodiments, The LLMEM 406 may be configured to generate a plurality of datasets with over two hundreds time series samples each, but the disclosure is not limited thereto. Within each dataset the time series length may be randomly chosen between 30 and 150 to encompass a variety of both short and long time series data. In order to make the time series more realistic, the LLMEM 406 may be configured to add a time index, using predominantly daily frequency.

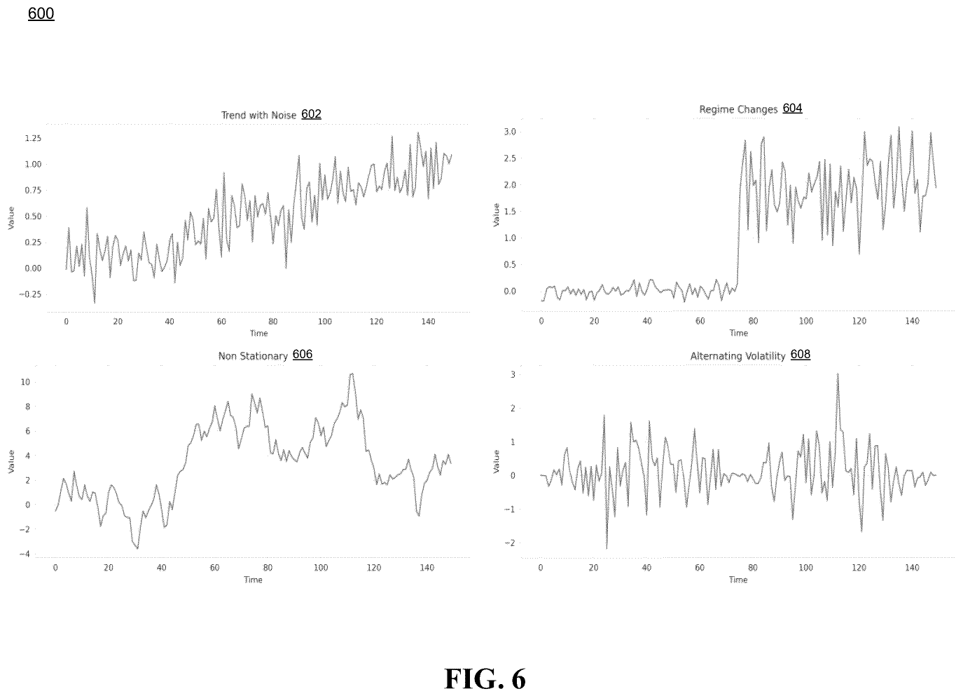

For example, FIG. 6 illustrates an exemplary graph 600 illustrating examples of generated univariate time series implemented by the LLMEM 406 of FIG. 4 in accordance with an exemplary embodiment. The graph 600 illustrates examples of generated univariate time series. Each univariate dataset showcases a unique single-dimensional patterns, whereas multivariate data explore series interrelations to reveal underlying patterns. For example, the graph 602 illustrates trend with noise, the graph 604 illustrates regime changes, the graph 606 illustrates non stationary, and the graph 608 illustrates alternating volatility.

For time series benchmark tasks, the evaluation framework is designed to assess the LLMs' capabilities in analyzing time series across the dimensions in the taxonomy. The evaluation includes four primary tasks: feature detection, feature classification, information retrieval, and arithmetic reasoning.

1. Feature Detection—This task evaluates the LLMs' ability to identify the presence of specific features within a time series, such as trend, seasonality, or anomalies. For instance, given a time series dataset with an upward trend, the LLM is queried to determine if a trend exists. Queries are structured as yes/no questions to assess the LLMs' ability to recognize the presence of specific time series features, such as “Is a trend present in the time series?”

2. Feature Classification—Once a feature is detected, this task assesses the LLMs' ability to classify the feature accurately. For example, if a trend is present, the LLM must determine whether it is upward, downward, or non-linear. This task involves a QA setup where LLMs are provided with definitions of sub-features within the prompt. Performance is evaluated based on the correct identification of sub-features, using the F1 score to balance precision and recall. This task evaluates the models' depth of understanding and ability to distinguish between similar but distinct phenomena.

3. Information Retrieval evaluates the LLMs' accuracy in retrieving specific data points, such as values on a given date.

4. Arithmetic Reasoning focuses on quantitative analysis tasks, such as identifying minimum or maximum values. Accuracy and Mean Absolute Percentage Error (MAPE) are used to measure performance, with MAPE offering a precise evaluation of the LLMs' numerical accuracy.

Additionally, to account for nuanced aspects of time series analysis, the LLMEM 406 may be configured to propose to study the influence of multiple factors, including time series formatting, location of query data point in the time series, and time series length.

For performance metrics, the following metrics to report the performance of LLMs on various tasks are implemented by the LLMEM 406.

F1 Score—Applied to feature detection and classification, reflecting the balance between precision and recall.

Accuracy—Used for assessing the information retrieval and arithmetic reasoning tasks.

MAPE—implemented for numerical responses in the information retrieval and arithmetic reasoning tasks, providing a measure of precision in quantitative analysis.

For performance factors, the LLMEM 406 may identify various factors that could affect the performance of LLMs on time series understanding. And for each, the LLMEM 406 may be configured design deep-dive experiments to reveal the impacts. The various factors may include the following, but the disclosure is not limited thereto.

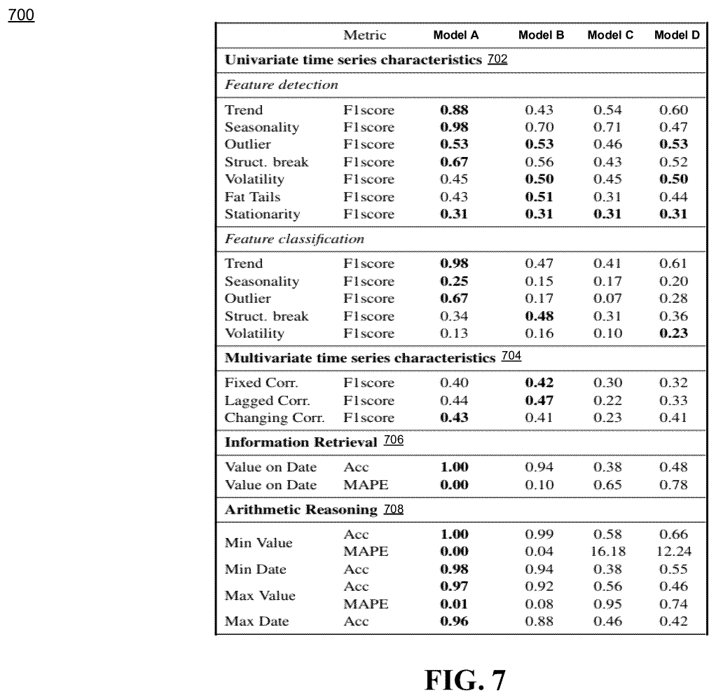

Time Series Formatting—Extracting useful information from raw sequential data as in the case of numerical time series is a challenging task for LLMs. The tokenization directly influences how the patterns are encoded within tokenized sequences, and methods such as byte-pair encoding (BPE) separates a single number into tokens that are not aligned. On the contrary, Model C (see, e.g., FIG. 7) has a consistent tokenization of numbers, where it splits each digit into an individual token, which ensures consistent tokenization of numbers. The LLMEM 406 may be configured to study different time series formatting approaches to determine if they influence the LLMs performance to capture the time series information. In total, the LLMEM 406 may be configured to propose 9 formats, ranging from simple CSV to enriched formats with additional information, but the disclosure is not limited thereto.

Time Series Length—the LLMEM 406 may be configured to study the impact that the length of the time series has in the retrieval task. Transformer-based models use attention mechanisms to weigh the importance of different parts of the input sequence. Longer sequences can dilute the attention mechanism's effectiveness, potentially making it harder for the model to focus on the most relevant parts of the text.

Position Bias—Given a retrieval question, the position of where the queried data point occurs in the time series might impact the retrieval accuracy. Studies have discovered recency bias in the task of few-shot classification, where the LLM tends to repeat the label at the end. Thus, it's important to investigate whether LLM exhibits similar bias on positions in the task of time series understanding.

According to exemplary embodiments, the LLMEM 406 evaluated the following LLM models: 1) Model A, 2) Model B, 3) Model C, and 4) Model D. The LLMEM 406 selected two open-source models, Model C and Model D, each with 13 billion parameters (but, not limited thereto), and the version of Model D is trained by fine-tuning Model C. Additionally, the LLMEM 406 selected Model A and Model B where the number of parameters is unknown. In the execution of our experiments, the LLMEM 406 used a computing service equipped with four GPUs each featuring 24 GB of GPU RAM, but the disclosure is not limited thereto. This setup was essential for handling both extensive datasets and the computational demands of LLMs.

### Prompts

The design of prompts for interacting with LLMs is separated into two approaches: retrieval/arithmetic reasoning and detection/classification questioning. Example of multi-turn prompt template used for time series feature detection and classification may include the following:

“Input:<time series>.”

### Question 1: Detection

“Question: can you detect a general upward or downward trend in this time series?Answer yes or no only.”

### Question 2: Classification

“Select one of the following answers: (a) the time series has a positive trend, (b) the time series has a negative trend. Provide your answer as either (a) or (b).

Time series characteristics—To evaluate the LLM reasoning over time series features, the LLMEM 406 may be configured to use a two-step prompt with an adaptive approach, dynamically tailoring the interaction based on the LLM's responses. The first step involves detection, where the model is queried to identify relevant features within the data. If the LLM successfully detects a feature, the LLMEM 406 may be configured to proceed with a follow-up prompt, designed to classify the identified feature between multiple sub-categories. For this purpose, the LLMEM 406 may be configured to enrich the prompts with definitions of each sub-feature (e.g. up or down trend), ensuring a clearer understanding and more accurate identification process. An example of this two-turn prompt is shown above.

Information Retrieval/Arithmetic Reasoning—The LLMEM 406 may be configured to test the LLM's comprehension of numerical data represented as text by querying it for information retrieval and numerical reasoning, as exemplified below.

“Input:<time series>.
Given the input time series, please provide brief and precise answers to the following questions and format your responses in a dictionary:
‘max_value’: ‘Maximum value and its date.’,
‘min value’: ‘Minimum value and its date.’,
‘value_on_date’: ‘Value of the time series on
<date>’.
Note: Only provide the numerical value and/or the date as the answer for each question.

### Benchmark Results

FIG. 7 illustrates an exemplary table 700 illustrating performances across all reasoning tasks implemented by the LLMEM 406 of FIG. 4 in accordance with an exemplary embodiment. The results for univariate time series feature detection and classification tasks illustrate Model A's robustness in trend and seasonality detection, substantially outperforming Model C and Model D. However, the detection of structural breaks and volatility presents challenges across all models, with lower accuracy scores. Model A excels in trend classification tasks, demonstrating superior performance. However, in classifying seasonality, outliers, and structural breaks, performance is mixed, with Model D sometimes surpassing Model C, highlighting the distinct strengths of each model.

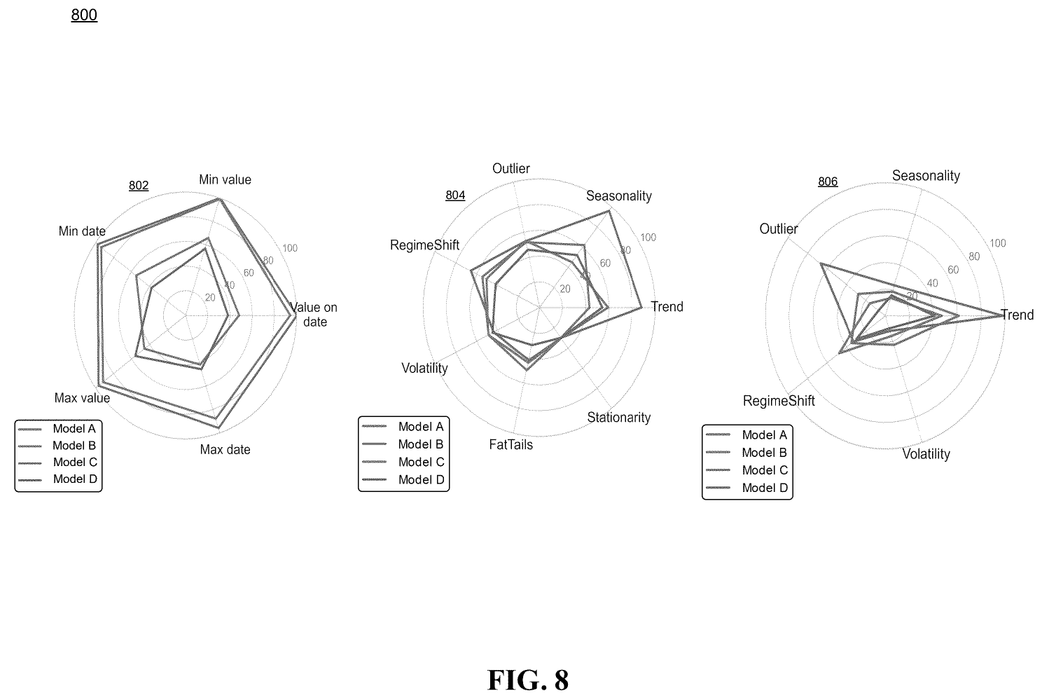

For example, FIG. 8 illustrates an exemplary graph 800 illustrating feature detection and classification scores of various models implemented by the LLMEM 406 of FIG. 4 in accordance with an exemplary embodiment. The exemplary graph 800 including graphs 802, 804, and 806 illustrate feature detection and classification scores of Model A, Model B, Model D, and Model C. The graphs 802, 804, and 806 summarize the accuracy performance for the information retrieval and arithmetic reasoning tasks, and F1 score for the feature detection and classification tasks for all models. In multivariate time series feature detection and classification tasks, all models achieve moderate accuracy, suggesting potential for enhancement in intricate multivariate data analysis.

As illustrated in graphs 802, 804, and 806, for information retrieval tasks, Model A outperforms Model B and other models, achieving perfect accuracy in identifying the value on a given date. It also maintains a low MAPE, indicative of its precise value predictions. The arithmetic reasoning results echo these findings, with Model A displaying superior accuracy, especially in determining minimum and maximum values within a series.

### Deep Dive on Performance Factors

Time Series Formatting—four formatting approaches are implemented by the LLMEM 406, 1) csv, which is a common comma separated value, 2) plain, where the time series is formatted as Date:YYYY-MM-DD,Value:num for each pair date value. The LLMEM 406 also utilizes the formatting approach of 3) denominating spaces that adds blank spaces between each digit of the time series, tokenizing each digit individually, and 4) symbol, an enriched format where a column is added to the time series with arrows indicating if the value has moved up, down or remained unchanged.

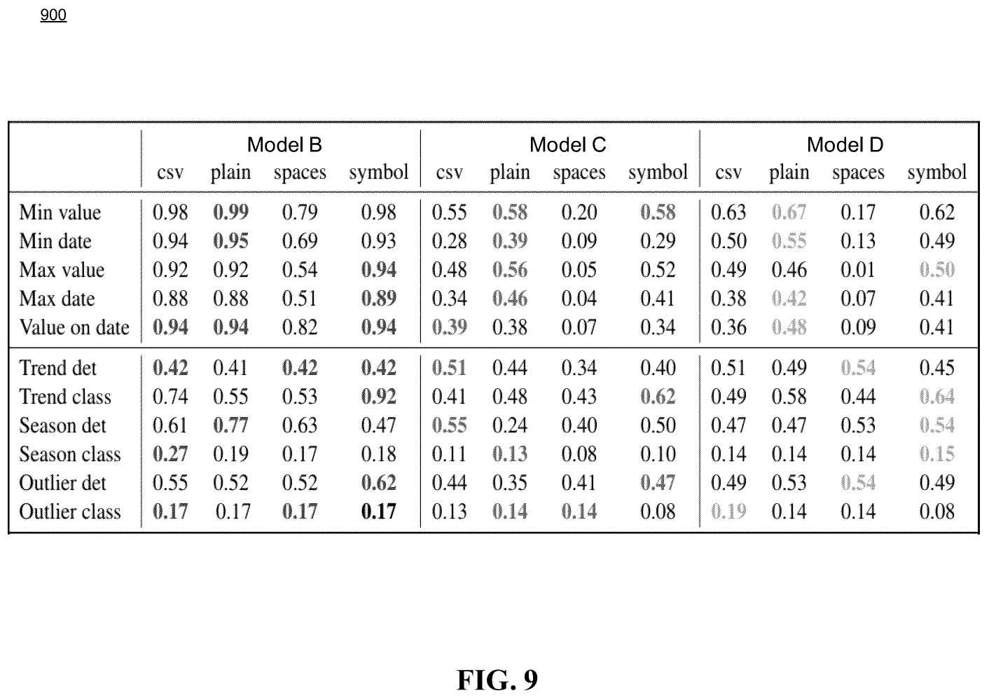

For example, FIG. 9 illustrates an exemplary table 900 illustrating time series feature detection and classification performance measured with F1 score implemented by the LLMEM 406 of FIG. 4 in accordance with an exemplary embodiment. Table 900 shows the results for the four time series formatting strategies csv, plain, spaces, and symbol. For the information retrieval and arithmetic reasoning tasks, the plain formatting yields better results across all models. This approach provides more structure to the input, and outperforms other formats in a task where the connection between time and value is important. For the detection and classification tasks, the plain formatting does not yield better results. Interestingly the symbol formatting that adds an additional column to the time series yields better results in the trend classification task. This means that the LLMs can correctly map the symbol to the time series movement and use it to achieve the best performance in trend classification. Furthermore, Model B leverages this additional information in the trend and anomalies datasets but not in the seasonality dataset.

### Time Series Length

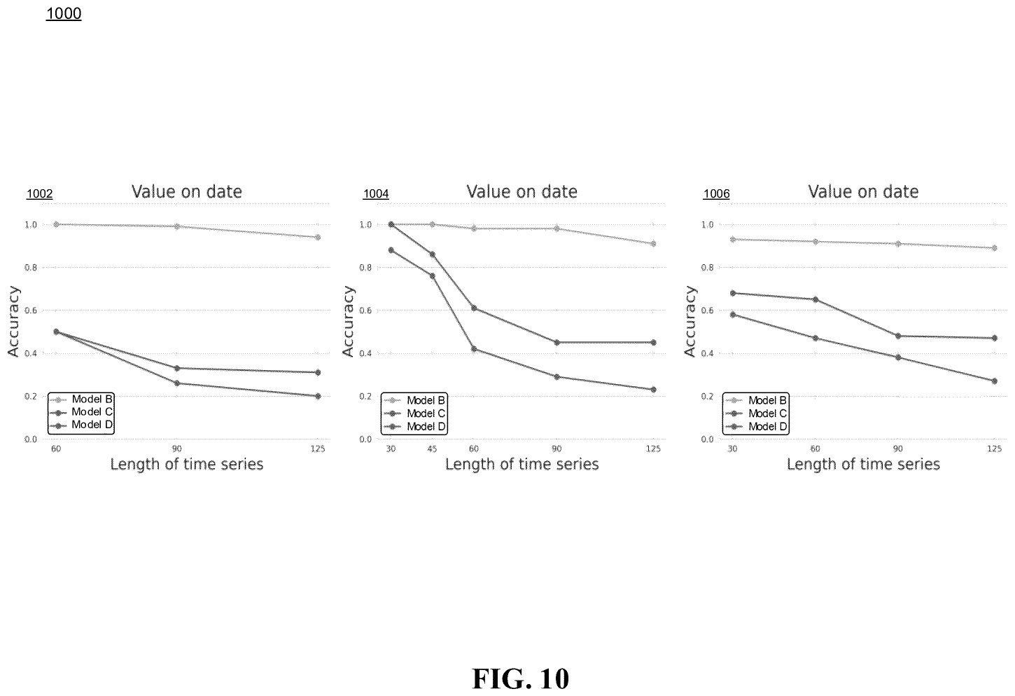

FIG. 10 illustrates an exemplary graph 1000 illustrating retrieval performance for different time series lengths implemented by the LLMEM 406 of FIG. 4 in accordance with an exemplary embodiment. The graphs 1002, 1004, and 1006 illustrate the performance of Model B, Model C and Model D on three datasets, trend, seasonality, and outliers which have time series with different lengths. It is observed that Model B retrieval performance degrades slowly with increasing sequence length. Model C and Model D suffers a more steep degradation especially from time series of length 30 steps to 60 steps; for longer sequences the degradation in performance becomes linear.

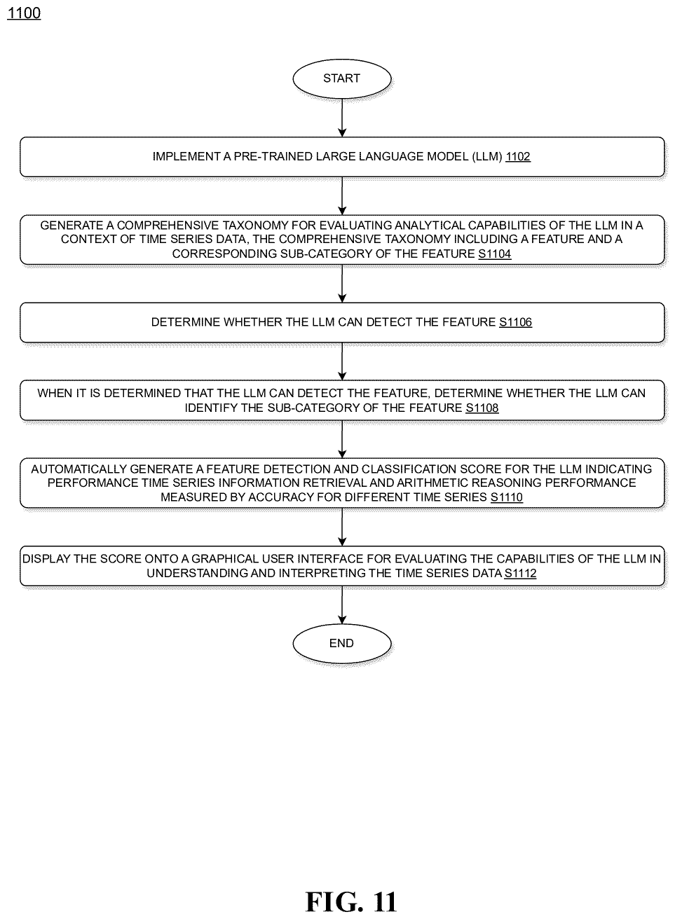

FIG. 11 illustrates an exemplary flow chart of a process 1100 implemented by the platform, language, database, and cloud agnostic LLMEM 406 of FIG. 4 for evaluating the capabilities of LLMs on time series understanding, encompassing both univariate and multivariate forms in accordance with an exemplary embodiment. It may be appreciated that the illustrated process 1100 and associated steps may be performed in a different order, with illustrated steps omitted, with additional steps added, or with a combination of reordered, combined, omitted, or additional steps.

As illustrated in FIG. 11, at step S1102, the process 1100 may include implementing a pre-trained LLM.

At step S1104, the process 1100 may include generating a comprehensive taxonomy for evaluating analytical capabilities of the LLM in a context of time series data, the comprehensive taxonomy including a feature and a corresponding sub-category of the feature.

At step S1106, the process 1100 may include determining whether the LLM can detect the feature; when it is determined that the LLM can detect the feature.

At step S1108, the process 1100 may include when it is determined that the LLM can detect the feature, determining whether the LLM can identify the sub-category of the feature.

At step S1110, the process 1100 may include automatically generating a feature detection and classification score for the LLM indicating performance time series information retrieval and arithmetic reasoning performance measured by accuracy for different time series.

At step S1112, the process 1100 may include displaying the score onto a graphical user interface for evaluating the capabilities of the LLM in understanding and interpreting the time series data.

According to exemplary embodiments, the comprehensive taxonomy may categorize intrinsic characteristics of time series features, providing a structured basis for assessing proficiency of the LLM in identifying and extracting these features.

According to exemplary embodiments, the process 1100 may further include: designing time series of datasets corresponding to the generated comprehensive taxonomy; outlining an evaluation framework incorporating specific metrics to quantify performance of the LLM model across a plurality of tasks; and implementing the evaluation framework to quantify performance of the LLM model across the plurality of tasks.

According to exemplary embodiments, in determining whether the LLM can detect the feature, the process 1100 may further include: querying the model to identify relevant features within the time series data.

According to exemplary embodiments, the process 1100 may further include: when it is determined that the LLM has successfully detected the feature, implementing a follow-up prompt designed to classify the identified feature between multiple sub-categories.

According to exemplary embodiments, the process 1100 may further include: enriching the prompts with definitions of each sub-category.

According to exemplary embodiments, the process 1100 may further include: testing the LLM's comprehension of numerical data represented as text by querying the LLM for information retrieval and numerical reasoning.

According to exemplary embodiments, the LLMED 402 may include a memory (e.g., a memory 106 as illustrated in FIG. 1) which may be a non-transitory computer readable medium that may be configured to store instructions for implementing a platform, language, database, and cloud agnostic LLMEM 406 for evaluating large language models on time series feature understanding as disclosed herein. The LLMED 402 may also include a medium reader (e.g., a medium reader 112 as illustrated in FIG. 1) which may be configured to read any one or more sets of instructions, e.g., software, from any of the memories described herein. The instructions, when executed by a processor embedded within the LLMEM 406 or within the LLMED 402, may be used to perform one or more of the methods and processes as described herein. In a particular embodiment, the instructions may reside completely, or at least partially, within the memory 106, the medium reader 112, and/or the processor 104 (see FIG. 1) during execution by the LLMED 402.

According to exemplary embodiments, the instructions, when executed, may cause a processor embedded within the LLMEM 406 or the LLMED 402 to perform the following: implementing a pre-trained LLM; generating a comprehensive taxonomy for evaluating analytical capabilities of the LLM in a context of time series data, the comprehensive taxonomy including a feature and a corresponding sub-category of the feature, wherein in evaluating analytical capabilities of the LLM in the context of time series data, the instructions, when executed, may cause the processor to further perform the following: determining whether the LLM can detect the feature; when it is determined that the LLM can detect the feature, determining whether the LLM can identify the sub-category of the feature; automatically generating a feature detection and classification score for the LLM indicating performance time series information retrieval and arithmetic reasoning performance measured by accuracy for different time series; and displaying the score onto a graphical user interface for evaluating the capabilities of the LLM in understanding and interpreting the time series data. According to exemplary embodiments, the processor may be the same or similar to the processor 104 as illustrated in FIG. 1 or the processor embedded within the LLMED 202, LLMED 302, LLMED 402, and LLMEM 406 which is the same or similar to the processor 104.

According to exemplary embodiments, the instructions, when executed, may cause the processor 104 to further perform the following: designing time series of datasets corresponding to the generated comprehensive taxonomy; outlining an evaluation framework incorporating specific metrics to quantify performance of the LLM model across a plurality of tasks; and implementing the evaluation framework to quantify performance of the LLM model across the plurality of tasks.

According to exemplary embodiments, in determining whether the LLM can detect the feature, the instructions, when executed, may cause the processor 104 to further perform the following: querying the model to identify relevant features within the time series data.

According to exemplary embodiments, the instructions, when executed, may cause the processor 104 to further perform the following: when it is determined that the LLM has successfully detected the feature, implementing a follow-up prompt designed to classify the identified feature between multiple sub-categories.

According to exemplary embodiments, the instructions, when executed, may cause the processor 104 to further perform the following: enriching the prompts with definitions of each sub-category.

According to exemplary embodiments, the instructions, when executed, may cause the processor 104 to further perform the following: testing the LLM's comprehension of numerical data represented as text by querying the LLM for information retrieval and numerical reasoning.

According to exemplary embodiments as disclosed above in FIGS. 1-11, technical improvements effected by the instant disclosure may include a platform for implementing a platform, language, database, and cloud agnostic LLM evaluating module configured for evaluating the capabilities of LLMs on time series understanding, encompassing both univariate and multivariate forms, but the disclosure is not limited thereto. For example, to systematically evaluate the performance of general-purpose LLMs on generic time series understanding, the LLMED 202, 302, 402 including the LLMEM 406 as disclosed herein may be configured to generate a taxonomy of time series features for both univariate and multivariate time series. This taxonomy provides a structured categorization of core characteristics of time series across domains. Building upon this taxonomy, the LLMED 202, 302, 402 including the LLMEM 406 as disclosed herein may configured to synthesize a diverse dataset of time series covering different features in the taxonomy. This dataset may prove to be pivotal to the evaluation framework, as it provides a robust basis for assessing LLMs' ability to interpret and analyze time series data accurately. Specifically, the LLMED 202, 302, 402 including the LLMEM 406 as disclosed herein may configured to examine the state-of-the-art LLMs' performance across a range of tasks on a vast number of dataset, including time series features detection and classification, data retrieval as well as arithmetic reasoning, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for evaluating large language models on time series feature understanding by utilizing one or more processors along with allocated memory, the method comprising:
implementing a pre-trained large language model (LLM);
generating a comprehensive taxonomy for evaluating analytical capabilities of the LLM in a context of time series data, the comprehensive taxonomy including a feature and a corresponding sub-category of the feature, wherein in evaluating analytical capabilities of the LLM in the context of time series data, the method further comprising:
determining whether the LLM can detect the feature;
when it is determined that the LLM can detect the feature, determining whether the LLM can identify the sub-category of the feature;
automatically generating a feature detection and classification score for the LLM indicating performance time series information retrieval and arithmetic reasoning performance measured by accuracy for different time series; and
displaying the score onto a graphical user interface for evaluating the capabilities of the LLM in understanding and interpreting the time series data.

2. The method according to claim 1, wherein the comprehensive taxonomy categorizes intrinsic characteristics of time series features, providing a structured basis for assessing proficiency of the LLM in identifying and extracting these features.

3. The method according to claim 2, further comprising:
designing time series of datasets corresponding to the generated comprehensive taxonomy;
outlining an evaluation framework incorporating specific metrics to quantify performance of the LLM model across a plurality of tasks; and
implementing the evaluation framework to quantify performance of the LLM model across the plurality of tasks.

4. The method according to claim 1, determining whether the LLM can detect the feature, the method further comprising:
querying the model to identify relevant features within the time series data.

5. The method according to claim 4, further comprising:
when it is determined that the LLM has successfully detected the feature, implementing a follow-up prompt designed to classify the identified feature between multiple sub-categories.

6. The method according to claim 5, further comprising:
enriching the prompts with definitions of each sub-category.

7. The method according to claim 1, further comprising:
testing the LLM's comprehension of numerical data represented as text by querying the LLM for information retrieval and numerical reasoning.

8. A system for evaluating large language models on time series feature understanding, the system comprising:
a processor; and
a memory operatively connected to the processor via a communication interface, the memory storing computer readable instructions, when executed, causes the processor to:
implement a pre-trained large language model (LLM);
generate a comprehensive taxonomy for evaluating analytical capabilities of the LLM in a context of time series data, the comprehensive taxonomy including a feature and a corresponding sub-category of the feature, wherein in evaluating analytical capabilities of the LLM in the context of time series data, the processor is further configured to:
determine whether the LLM can detect the feature;
when it is determined that the LLM can detect the feature, determine whether the LLM can identify the sub-category of the feature;
automatically generate a feature detection and classification score for the LLM indicating performance time series information retrieval and arithmetic reasoning performance measured by accuracy for different time series; and
display the score onto a graphical user interface for evaluating the capabilities of the LLM in understanding and interpreting the time series data.

9. The system according to claim 8, wherein the comprehensive taxonomy categorizes intrinsic characteristics of time series features, providing a structured basis for assessing proficiency of the LLM in identifying and extracting these features.

10. The system according to claim 9, wherein the processor is further configured to:
design time series of datasets corresponding to the generated comprehensive taxonomy;
outline an evaluation framework incorporating specific metrics to quantify performance of the LLM model across a plurality of tasks; and
implement the evaluation framework to quantify performance of the LLM model across the plurality of tasks.

11. The system according to claim 8, determining whether the LLM can detect the feature, the processor is further configured to:
query the model to identify relevant features within the time series data.

12. The system according to claim 11, wherein the processor is further configured to:
when it is determined that the LLM has successfully detected the feature, implement a follow-up prompt designed to classify the identified feature between multiple sub-categories.

13. The system according to claim 12, wherein the processor is further configured to:
enrich the prompts with definitions of each sub-category.

14. The system according to claim 8, wherein the processor is further configured to:
test the LLM's comprehension of numerical data represented as text by querying the LLM for information retrieval and numerical reasoning.

15. A non-transitory computer readable medium configured to store instructions for evaluating large language models on time series feature understanding, the instructions, when executed, cause a processor to perform the following:
implementing a pre-trained large language model (LLM);
generating a comprehensive taxonomy for evaluating analytical capabilities of the LLM in a context of time series data, the comprehensive taxonomy including a feature and a corresponding sub-category of the feature, wherein in evaluating analytical capabilities of the LLM in the context of time series data, the method further comprising:
determining whether the LLM can detect the feature;
when it is determined that the LLM can detect the feature, determining whether the LLM can identify the sub-category of the feature;
automatically generating a feature detection and classification score for the LLM indicating performance time series information retrieval and arithmetic reasoning performance measured by accuracy for different time series; and
displaying the score onto a graphical user interface for evaluating the capabilities of the LLM in understanding and interpreting the time series data.

16. The non-transitory computer readable medium according to claim 15, wherein the comprehensive taxonomy categorizes intrinsic characteristics of time series features, providing a structured basis for assessing proficiency of the LLM in identifying and extracting these features.

17. The non-transitory computer readable medium according to claim 16, wherein the instructions, when executed, cause the processor to further perform the following:
designing time series of datasets corresponding to the generated comprehensive taxonomy;
outlining an evaluation framework incorporating specific metrics to quantify performance of the LLM model across a plurality of tasks; and
implementing the evaluation framework to quantify performance of the LLM model across the plurality of tasks.

18. The non-transitory computer readable medium according to claim 15, determining whether the LLM can detect the feature, the instructions, when executed, cause the processor to further perform the following:
querying the model to identify relevant features within the time series data.

19. The non-transitory computer readable medium according to claim 18, wherein the instructions, when executed, cause the processor to further perform the following:
when it is determined that the LLM has successfully detected the feature, implementing a follow-up prompt designed to classify the identified feature between multiple sub-categories.

20. The non-transitory computer readable medium according to claim 19, wherein the instructions, when executed, cause the processor to further perform the following:
enriching the prompts with definitions of each sub-category.
